(19) United States
(12) Patent Application Publication
(10) Pub. No.: US 2025/0335619 A1
(43) Pub. Date: Oct. 30, 2025

(54) SYSTEMS AND METHODS FOR CONTROLLING DATA USAGE BY END USERS

(71) Applicant: State Farm Mutual Automobile Insurance Company, Bloomington, IL (US)

(72) Inventors: Vaidehi Ganta, Bloomington, IL (US); Kevin Knipmeyer, Sebastian, FL (US); Molly Bonney, Mabank, TX (US)

(21) Appl. No.: 19/059,126

(22) Filed: Feb. 20, 2025

Related U.S. Application Data
(60) Provisional application No. 63/639,257, filed on Apr. 26, 2024.

(51) Int. Cl. G06F 21/62

(52) U.S. Cl. CPC G06F 21/6218

(57) ABSTRACT

A computing system including at least one memory and at least one processor in communication with the at least one memory is disclosed. The at least one processor is programmed to: (i) generate a first interface for a data producer to register a data resource and to input conditions for using data of the data resource; (ii) cause the registered data resource to be added in a data catalog; (iii) generate a second interface for a data consumer to search the data catalog and request access to the data resource; (iv) generate a third interface for the data consumer to input a use case for the data resource; and (v) generate a data contract based at least in part upon the conditions for using data of the data resource and the use case inputted by the data consumer.

### CROSS-REFERENCE TO RELATED APPLICATION

This application claims priority to U.S. Provisional Patent Application No. 63/639,257, filed Apr. 26, 2024, entitled “SYSTEMS AND METHODS FOR CONTROLLING DATA USAGE BY ENDUSERS,” the entire contents of which are hereby incorporated by reference in their entirety for all purposes.

### FIELD OF THE DISCLOSURE

The present disclosure generally relates to controlling data usage by end users, and, more particularly, to network-based systems and methods for automatically and dynamically generating data contracts for controlling how data is used by end users within a computer network.

### BACKGROUND

In the data industry, data producers may play a critical role in providing data that enables data consumers to make informed decisions based upon analysis of the data. Data producers may collect and generate data, for example, by capturing user interactions, sensor data, and/or from other external or specific resources or processes. The data may then be provided to data consumers, upon receiving a request for data access therefrom.

Oftentimes, requests for data may be made via email, and access to data may be granted or denied via email. In many of these cases, the mechanisms that may be required to ensure data integrity, data security, data reliability may be missing or not a concern for either the data producers or the data consumers.

Additionally, the types of data that may be available from such data producers and the different use cases of such data may not be clear to the data producers or the data consumers. Therefore, a substantial amount of human resources and time may be involved in ensuring that the data producers have a correct or desired type of data for the specific use case(s) of data consumers. Similarly, a substantial amount of human resources and time may be involved in ensuring that the data being provided by the data producers is being used by the data consumer in a manner intended by the data producer. Conventional techniques may include additional inefficiencies, encumbrances, ineffectiveness, and/or other drawbacks as well.

### BRIEF SUMMARY

The present embodiments may relate to, inter alia, a system that may automatically and dynamically generate data contracts for defining the type of data being provided (e.g., from a data source or producer to a data consumer) and controlling how the data is used by data consumers within a computer network. For instance, a computer system and computer-based method that include automatically and dynamically generating data contracts for controlling the usage of data by data consumers within a data mesh computer architecture having distributed ownership and federated governance of data may be provided. The systems and methods described herein may include a computing device, sometimes referred to herein as a “Data Control computing device” or “DC computing device,” configured to control usage of data that is included within the data mesh computer architecture. The systems and methods described herein may control such data that is made available to data consumers for specific use cases, by automatically and dynamically generating data contracts that grant the data consumers certain rights to use the data for the specific use cases only.

In the present embodiments, the DC computing device may be configured to enable the data producer to define rules and methodologies for use of the data by the data consumers. The data contracts that are created between the data producers and the data consumers may be generated automatically and dynamically to include a Service Level Agreement (SLA) and a Document Of Understanding (DOU) that may be binding on the data producer and/or the data consumer. The SLA and DOU may describe customized rules of data usage, a mode of data usage, and/or a technology to use for data storage such as, for example, Amazon Simple Storage Service™ (Amazon S3™) or Amazon Redshift™.

In one example embodiment, the DC computing device may generate the contract in a plug-and-play manner, such as by modifying a default template to include the parameters or restrictions desired by the data producers or consumers. Upon the binding contract being generated, access to data pursuant to any restrictions identified in the contract may be automatically granted to the data consumer for the specific use case(s) described in the automatically generated contract. The data made available to the data consumer under the DOU and SLA may be published by the data producer defining how the data producer intends to allow access to the data and for what use cases.

In one aspect, a computing system for generating a data contract between a data producer and a data consumer for usage of a data resource may be provided. The computing system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another and/or operate as input and/or output devices. For instance, the computing system may include at least one memory and at least one processor in communication with the at least one memory. The at least one processor may be programmed to: (i) generate a first interface for the data producer to register the data resource and to input conditions for using data of the data resource; (ii) cause the registered data resource to be added in a data catalog; (iii) generate a second interface for the data consumer to search the data catalog and request access to the data resource; (iv) generate a third interface for the data consumer to input a use case for the data resource; and/or (v) generate the data contract based at least in part upon the conditions for using data of the data resource and the use case inputted by the data consumer. The computing system may include additional, less, or alternate functionality, including that discussed elsewhere herein.

In another aspect, a computer-implemented method for generating a data contract between a data producer and a data consumer for usage of a data resource may be provided. The computer-implemented method may be performed by a computing system including at least one processor in communication with at least one memory device. The method may include: (i) generating a first interface for the data producer to register the data resource and to input conditions for using data of the data resource; (ii) causing the registered data resource to be added in a data catalog; (iii) generating a second interface for the data consumer to search the data catalog and request access to the data resource; (iv) generating a third interface for the data consumer to input a use case for the data resource; and/or (v) generating the data contract based at least in part upon the conditions for using data of the data resource and the use case inputted by the data consumer. The computer-implemented method may include additional, less, or alternate actions, including those discussed elsewhere herein.

In yet another aspect, at least one non-transitory computer-readable storage media having instructions stored thereon is disclosed. The instructions, when executed by at least one processor of a computing system for generating a data contract between a data producer and a data consumer for usage of a data resource, cause the at least one processor to: (i) generate a first interface for the data producer to register the data resource and to input conditions for using data of the data resource; (ii) cause the registered data resource to be added in a data catalog; (iii) generate a second interface for the data consumer to search the data catalog and request access to the data resource; (iv) generate a third interface for the data consumer to input a use case for the data resource; and/or (v) generate the data contract based at least in part upon the conditions for using data of the data resource and the use case inputted by the data consumer. The instructions may cause the at least one processor to perform additional, less, or alternate actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 depicts an exemplary portal or platform for accessing a data control (DC) computing device that may be used by data producers and data consumers for establishing a communication channel therebetween, in accordance with one embodiment of the present disclosure.

FIG. 2 depicts an exemplary flowchart of a plurality of processing blocks performed or executed by the DC computing device for generating a data contract (or data control contract) in accordance with one embodiment of the present disclosure.

FIG. 3 depicts another exemplary flowchart of a plurality of processing blocks for registering a resource, requesting access to the registered resource, and/or reviewing and approving a request for data access in accordance with one embodiment of the present disclosure.

FIG. 4 depicts an exemplary configuration of a user device or user equipment executing a mobile application of the data control system in accordance with one embodiment of the present disclosure.

FIG. 5 depicts an exemplary configuration of an application server or DC computing device in accordance with one embodiment of the present disclosure.

FIGS. 6A-6B depict exemplary user interfaces or screen views of a web-browser based application or a mobile application executing on a user device or user equipment of a data producer and/or a data consumer in accordance with one embodiment of the present disclosure.

FIG. 7 depicts an exemplary user interface or a screen view of a web-browser based application or a mobile application executing on a user device or user equipment of a data consumer to view or request access to data from a data source in accordance with one embodiment of the present disclosure.

FIG. 8 depicts an exemplary user interface or a screen view of a web-browser based application or a mobile application executing on a user device or user equipment of a data consumer showing properties of a data source in accordance with one embodiment of the present disclosure.

FIG. 9 depicts an exemplary user interface or a screen view of a web-browser based application or a mobile application executing on a user device or user equipment of a data consumer for providing inputs for a use case while requesting access to data from a data source in accordance with one embodiment of the present disclosure.

FIG. 10 depicts another exemplary user interface or a screen view of a web-browser based application or a mobile application executing on a user device or user equipment of a data consumer for providing inputs while requesting access to data from a data source in accordance with one embodiment of the present disclosure.

FIG. 11 depicts an exemplary user interface or a screen view of a web-browser based application or a mobile application executing on a user device or user equipment of a data consumer displaying toxic combinations while the data consumer is requesting access to data from a data source in accordance with one embodiment of the present disclosure.

FIG. 12 depicts an exemplary user interface or a screen view of a web-browser based application or a mobile application executing on a user device or user equipment of a data consumer or a data producer displaying an exemplary generated data control contract in accordance with one embodiment of the present disclosure.

FIG. 13 depicts an exemplary user interface or a screen view of a web-browser based application or a mobile application executing on a user device or user equipment of a data consumer showing status of a request to access data from a data source in accordance with one embodiment of the present disclosure.

FIG. 14 depicts an exemplary user interface or a screen view of a web-browser based application or a mobile application executing on a user device or user equipment of a data producer for creating a new dataset catalog entry in accordance with one embodiment of the present disclosure.

FIG. 15 depicts an exemplary user interface or a screen view of a web-browser based application or a mobile application executing on a user device or user equipment of a data producer for creating a new dataset catalog entry in accordance with one embodiment of the present disclosure.

FIG. 16 depicts an exemplary user interface or a screen view of a web-browser based application or a mobile application executing on a user device or user equipment of a data producer for creating a new dataset catalog entry in accordance with one embodiment of the present disclosure.

FIG. 17 depicts an exemplary user interface or a screen view of a web-browser based application or a mobile application executing on a user device or user equipment of a data producer for creating a new dataset catalog entry in accordance with one embodiment of the present disclosure.

FIG. 18 depicts an exemplary user interface or a screen view of a web-browser based application or a mobile application executing on a user device or user equipment of a data consumer to view or request access to data from a data source in accordance with one embodiment of the present disclosure.

FIG. 19 depicts an exemplary user interface or a screen view of a web-browser based application or a mobile application executing on a user device or user equipment of a data consumer to view or request access to data from a data source in accordance with one embodiment of the present disclosure.

FIG. 20 depicts an exemplary user interface or a screen view of a web-browser based application or a mobile application executing on a user device or user equipment of a data consumer to view or request access to data from a data source in accordance with one embodiment of the present disclosure.

FIG. 21 depicts an exemplary user interface or a screen view of a web-browser based application or a mobile application executing on a user device or user equipment of a data consumer to view or request access to data from a data source in accordance with one embodiment of the present disclosure.

FIG. 22 depicts an exemplary user interface or a screen view of a web-browser based application or a mobile application executing on a user device or user equipment of a data consumer to view or request access to data from a data source in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the present embodiments described herein.

### DETAILED DESCRIPTION OF THE DRAWINGS

The present embodiments may relate to, inter alia, a computer system and computer-based method configured to automatically and dynamically generate data contracts for controlling the usage of data by data consumers within a data mesh computer architecture having distributed ownership and federated governance of data. The systems and methods described herein may be referred to as a data control computer system, and may include a computing device, sometimes referred to herein as a “data control computing device” or “DC computing device,” configured to control the usage of data included within the data mesh computer architecture. Accordingly, the DC computing device enables a data producer to define rules and methodologies for use of the data by a data consumer. The contracts that bind the data producer and the data consumer may be generated automatically and dynamically to include a Service Level Agreement (SLA) and a Document Of Understanding (DOU). The SLA and DOU may describe customized rules of data usage, a mode of data usage, and/or a technology to use for data storage such as, Amazon Simple Storage Service™ (Amazon S3™) or Amazon Redshift™.

In one example, the DC computing device may generate a data contract in a plug-and-play manner. Upon the binding contract being generated, access to data pursuant to any restrictions identified in the contract may be automatically granted to the data consumer for the specific use case(s) described in the automatically generated contract. The data made available to the data consumer under the DOU and the SLA may be published by the data producer defining how the data producer intends to allow access to the data and for what use cases.

### Exemplary Portal to Publish Data in a Data Catalog and to Request Data Access

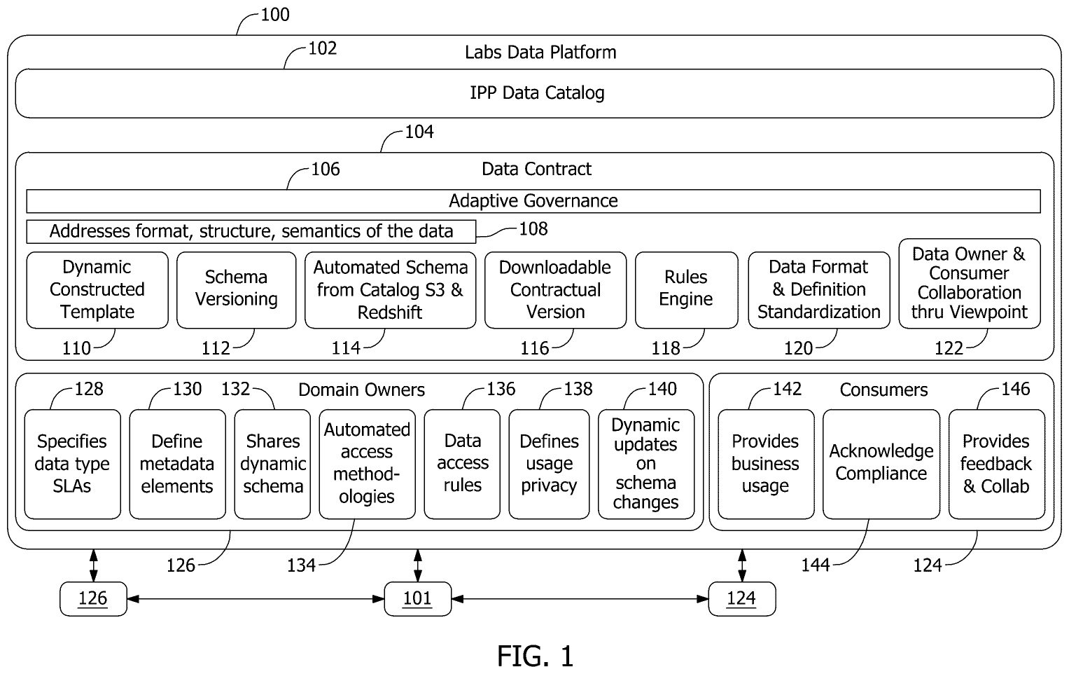

FIG. 1 depicts an exemplary portal or platform 100 that may be made accessible through a DC computing device 101 and is used by data producers and/or data consumers to establish a communication channel therebetween. In some embodiments, the portal or platform 100 may be a web-service or a micro-service established or implemented by or using the DC computing device 101, and the portal 100 may be used to query or discover data made available by one or more data producers (or domain owners) 126. For example, the portal 100 may be available to a data producer 126 or data consumer 124 via a respective computing device thereof, and may be embodied as one or more user interfaces enabling interaction with the portal 100 and/or the DC computing device 101. The data producers 126 may make their data available to one or more data consumers 124 by registering a data source with the portal 100. Data available at the registered data source may be available in a data catalog 102.

As described herein, the data producers 126 may define types of data sources, technology types, SLAs, types of data being hosted, and/or in which environment the data may be used during a data owner's process 128. By way of a non-limiting example, the data producer 126 may provide inputs during the data owner's process 128 using an application programming interface (API) call to the portal 100. The data producer's 126 inputs may be stored in tables within a database, for example, Amazon DynamoDB™, or any other database. Different database tables may be used to store data based upon a category of multiple available categories of the data catalog 102 selected by the data producer 126. Multiple categories of the data in the data catalog 102 may enable a data consumer 124 to query, search, and/or identify whether data suitable for the data consumer's 124 specific use case is available at the portal 100.

In some embodiments, the data consumer 124 may use an API call to the portal 100 to query, search, and/or identify data by providing 142 the specific use case or business usage for the data being requested. The data consumer 124 may select a particular data or data source from the data catalog 102 to request access to the data for the specific use case, for example, using another API call. In some embodiments, upon the data consumer 124 requesting access to the data, a questionnaire may be presented to the data consumer 124, prompting the data consumer 124 to provide responses to one or more additional questions. The questionnaire may be generated (e.g., by the DC computing device 101) based upon information provided by the data producer 126 during registration of the data or data source with the portal 100. The questionnaire may be generated based upon information including, but not limited to, data access rules 136, data usage and/or privacy 138, metadata elements 130, dynamic schema 132, access methodologies 134, and/or dynamic updates on schema changes 140. The DC computing device 101 may also request a confirmation or compliance acknowledgement 144 from the data consumer 124 agreeing to use the data provided by the data producer 126 according to the data access rules 136 and defined data usage 138 defined by the data producer 126.

Upon receiving responses and the compliance acknowledgement 144 from the data consumer 124, and, the data consumer's 124 responses may be saved in one or more database tables (e.g., by the DC computing device 101). The DC computing device 101 may also generate a unique record identification (ID) corresponding to this data access request from the data consumer 124. Additionally, or alternatively, a notification may be sent (e.g., by the DC computing device 101) to the data producer 126 regarding the data access request from the data consumer 124. The notification sent to the data producer 126 may include information about how to access the data access request from the data consumer 124.

Additionally, or alternatively, the DC computing device 101 may generate a contract 104, referred to herein as a data control contract 104, and transmit the data control contract 104 to the data producer 126 and/or the data consumer 124 for review and execution by the data producer 126 and/or data consumer 124. The data control contract 104 is an agreement between data producer 126 and data consumer 124, and includes defined terms and conditions, legally binding rules, and a scope of usage for adaptive governance 106 regarding what kind of data will be exchanged between the data producer 126 and the data consumer 124 as well as how the data will be exchanged. The DC computing device 101 may generate a first component and a second component of the data control contract 104, the first component related to a technical metadata aspect and the second component related to a licensing aspect. The technical metadata aspect may be associated with standardization and data quality and may help to define or impose rules for consistency. The licensing aspect may be associated with governance 106 or a contractual agreement between the data producer 126 and data consumer 124.

The DC computing device 101 may store the data control contract 104 as metadata, before or after agreement or execution between the data producer 126 and data consumer 124, for example, in a metastore. The data control contract 104 stored as metadata may play an important role for data pipeline execution, validation of data types and/or schemas, interoperability standards, protocol versions, defaulting rules on missing data, and so on. In other words, the data control contract 104 may include a plurality of technical metadata. In some embodiments, and by way of a non-limiting example, the technical metadata corresponding to the data control contract 104 may facilitate (i) establishing a framework through principles, processes, and responsibilities according to a dynamically constructed template 110; (ii) enabling agile contract development; (iii) providing a platform for collaboration and stakeholder engagement 122; (iv) version control mechanisms to manage changes for dynamic schema 112; and/or (v) contract life cycle management. Schemas may be automated schemas 114 from a catalog of Amazon S3™ and/or Amazon Redshift™. The data control contract 104 may include a rules engine 118 storing and executing rules of data usage, and a data format and definition standardization section 120. The portal 100 may provide a downloadable contractual version 116 of the data control contract 104 to the data consumer 124 and/or the data producer 126 (e.g., via the DC computing device 101) and may also enable an API call for the data consumer 124 to provide feedback 146.

The data control contract 104 may also provide clarity and consistency by including a clear and standardized definition of data structure, format, and semantics to ensure that all involved parties (e.g., the data producer and data consumer) have a shared understanding of the data being exchanged while reducing ambiguity and/or potential errors. The data control contract 104 may also promote or facilitate interoperability between different systems and/or components by defining a common data format for seamless data exchange and integration, even when the systems and/or components are developed by different vendors or operate on different platforms. In some instances, the DC computing device 101 may be configured to re-format or “translate” data from the data control contract 104 to another format accessible by the data producer 126 or the data consumer 124. The DC computing device 101 may generate the data control contract 104 to accommodate future changes and expansions in data requirements by using versioning mechanisms that enable backward compatibility and smooth transition when data structures or semantics evolve over time. This flexibility makes it easier to adapt and scale the data exchange process between disparate parties 124, 126.

Additionally, or alternatively, a well-defined data control contract 104 may provide efficiency and automation of data exchange processes. By way of a non-limiting example, data exchange processes may be automated (e.g., by the DC computing device 101) to validate data against the data control contract 104, ensuring compliance and reducing the need for manual intervention, and thereby improving efficiency and reducing the likelihood of data errors or inconsistencies. The data control contract 104 may reduce integration efforts and improve data governance and quality. In particular, integration efforts may be reduced because of the data contract being standardized, thereby enabling the parties 124, 126 to focus more on the contract specifications instead of negotiations and/or aligning data formats and structures.

The data control contract 104 may thus facilitate the establishment of data governance between the parties 124, 126, by enforcing standards and rules for data exchange and promote data quality and/or data reliability by ensuring data consistency, accuracy, and completeness, as specified in the data control contract 104. Additionally, or alternatively, the data control contract 104 may increase confidence for business owners or other data producers 126 to share data for use by data consumers 124, enable transparency and auditability, establish a communication channel between the data producer 126 and the data consumer 124, foster collaboration and trust, provide an opportunity for data owners 126 to share data knowledge through documentation, and/or eliminate a risk of misusing information by data consumers 124.

The data control contract 104 may include and/or describe a form type providing an adaptable template to federate governance, a data producer's 126 intent, a data consumer's 124 intent, and/or an access approach. By way of a non-limiting example, the data producer's 126 intent may be selectable (e.g., via the portal 100) from a plurality of intended access pattern options and may include one or more approval flows and/or contract details. The one or more approval flows may be available for selection by the data producer 126 based upon the type of dataset, and the contract details may be selectable template options. The template options may be provided based upon the type of dataset. The data consumer's 124 intent may capture a use case for which the data consumer 124 is requesting data access. The data consumer 124 may identify intended use case options from a list of selectable intended use cases (e.g., via the portal 100) to define the SLA. Additionally, or alternatively, the data consumer's 124 intent may also include selected data elements of the data catalog 102 and/or a selected access pattern of a list of available and/or approved access patterns.

Upon the data producer 126 accepting and granting the data access request, one or more processes to grant access to the data and enforce data integrity, security, and/or reliability may be automatically initiated by the DC computing device 101. Additionally, or alternatively, a data audit process may also be initiated to ensure that the data consumer 124 is using data according to the rules and/or restrictions in the data contract 104 as defined by the data producer. These processes may be initiated and performed as associated with the unique record ID, and thereby provides the data owners 126 tools to federate governance of the data made available to one or more data consumers 124.

The portal 100 for dynamically generating the data control contract 104 may provide a dynamic methodology for the data producers 126 to register and the data consumers 124 to consume data in a standardized approach with organizational adaptive governance. Further, the portal 100 may be a packageable model or a microservice engine that is pluggable to any data tool. The portal 100 may also facilitate API calls to, for example, download the executed data control contract, or an option to view the data catalog and/or a dashboard and graphs for leadership analytics, and/or evaluating strength and popularity of the registered and published datasets.

In some embodiments, the data consumer 124 may input details about the data consumer 124. The details about the data consumer 124 may include a name of a business organization (or a name of a person) requesting data access to data from a data source using the portal 100. The data consumer 124 may be provided details about the data source or a data set requested by the data consumer 124. Additionally, or alternatively, schema and data elements (and/or metadata) may be displayed to the data consumer 124. A check may be performed whether data elements are sensitive or non-sensitive data elements, and whether the data elements are combined with other elements forming toxic combinations prior to generating and saving the data control contract 104 as JavaScript Object Notation (JSON) in a database.

In some embodiments, various features of the portal 100 may be provided via microservices, or an API embedded within different ecosystems across an organization. Additionally, or alternatively, different knowledge items on data toxicity or unintended consequences of the publication of datasets by data producers 126 may be identified and exposed through the data control contracts 104, for understanding by both the data producer 126 and the data consumer 124. Different rule engines or rule systems may be identified, integrated, and/or displayed as part of the data control contract 104 for awareness of the data producer 126 and data consumer 124. Additionally, or alternatively, toxic combination references in metadata may be identified and automatically built in the rules engine. Various features of the portal 100 described herein may be provided using one or more machine learning (ML) or artificial intelligence (AI) based algorithms. By way of a non-limiting example, the AI based algorithms may be based upon generative AI based algorithms or tools. The ML or AI-based algorithms may be executed by the DC computing device 101.

### Exemplary Flowcharts of Generating a Data Contract Between a Data Producer and a Data Consumer

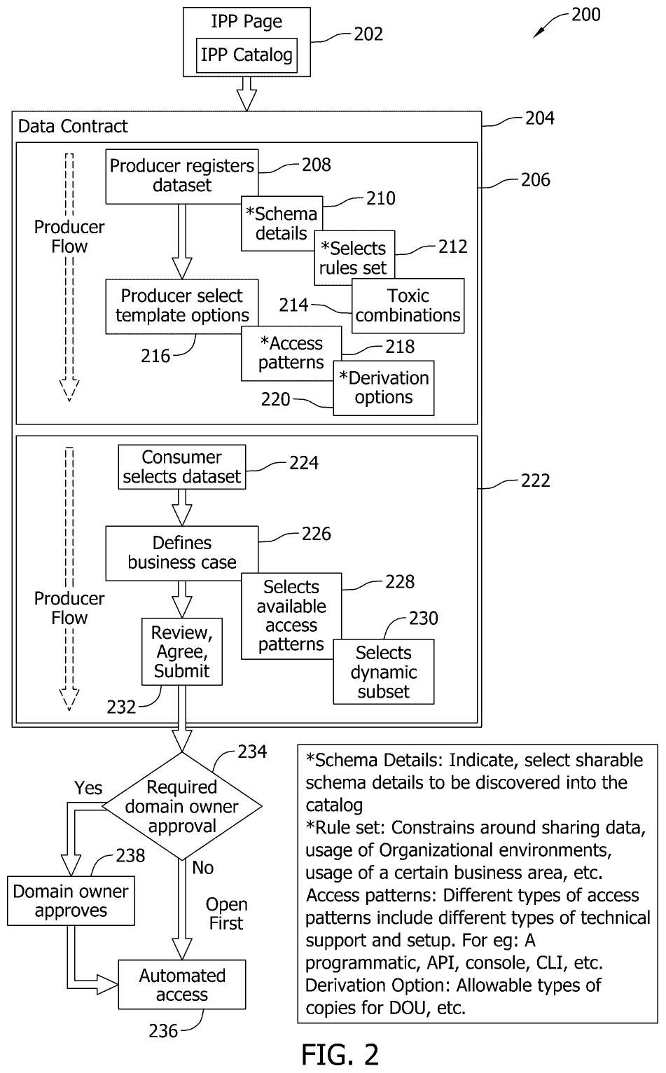

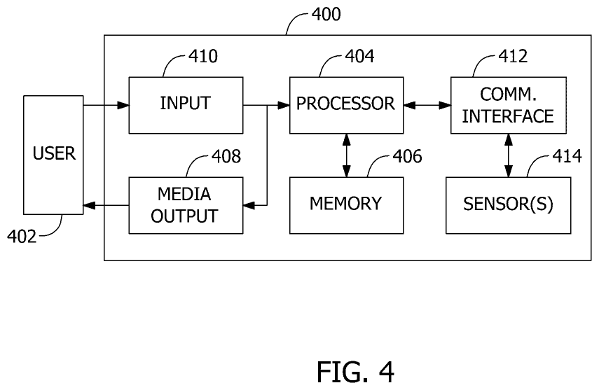

FIG. 2 depicts an exemplary flowchart 200 of a plurality of processing blocks that may be performed or executed for generating a data contract 204 (or data control contract 104 shown in FIG. 1). At least some of these processing blocks may be performed or executed by or via the DC computing device 101 and some processing blocks may be executed by or at a computing device associated with a data consumer 124 or a data product 126 (all shown in FIG. 1). Generating the data contract 204 includes a data producer's tasks 206 and a data consumer's tasks 222. The data producer's 126 tasks 206 may include registering 208 data resources or datasets for displaying in the data catalog 202. The data producer 126 may also select from one or more templates corresponding to schema details 210, rules set 212, and toxic combinations of reference metadata 214. The data producer 126 may also provide information corresponding to schema details 210, rules set 212, and toxic combinations of reference metadata 214 using an API, or a graphical user interface of a web-browser based application or a mobile application executing on a client device or a user device (shown in FIG. 4) of the data producer 126.

Additionally, or alternatively, the data producer 126 may select 216 template options from a list of predesignated template options regarding access patterns 218 and/or derivation options 220. Schema details 210 indicate sharable schema details that can be searched, queried, or discovered in the data catalog 202. The rules set 212 includes details or restrictions associated with data sharing, data usage, usage of organizational environment, usage of data for certain business use cases, etc. Access patterns 218 may provide different types of access patterns including different types of technical support and setup including, but not limited to, a programmable interface, an API, and/or a Command Line Interface (CLI), etc., to access the data from the registered datasets. Derivation options 220 may include allowable types of copies for DOU, SLA, etc.

The data consumer's 124 tasks 222 may include selecting 224 datasets from the data catalog 202, inputting or defining 226 a business case or use case for the one or more selected datasets, selecting 228 from available access patterns, and selecting 230 dynamic subsets of data corresponding to the one or more datasets from the data catalog 202. The data consumer 124 may then review and agree 232 to the terms and conditions of the data contract 204 and submit a response. The data contract 204 may be automatically and dynamically generated (e.g., by the DC computing device 101) using artificial intelligence-based algorithms based upon the inputs received from the data producer 126 and the data consumer 124.

In some cases, the data producer's 126 approval may be required before the data consumer 124 is granted access to the dataset. Accordingly, whether the data producer's 126 approval is needed or not may be checked 234. If no prior approval from the data producer 126 is required, and/or after the data producer 126 approves 238 the data access request from the data consumer 124, then various processes related to granting the data access request, enforcing data integrity, security, and/or reliability may be automatically initiated 236. Additionally, or alternatively, a data audit process may also be initiated to ensure that the data consumer 124 is using the data according to the rules and/or restrictions in the data contract 204 as defined by the data producer 126. The flowchart 200 shown in FIG. 2 may include additional, fewer, or alternate actions, including those discussed elsewhere herein.

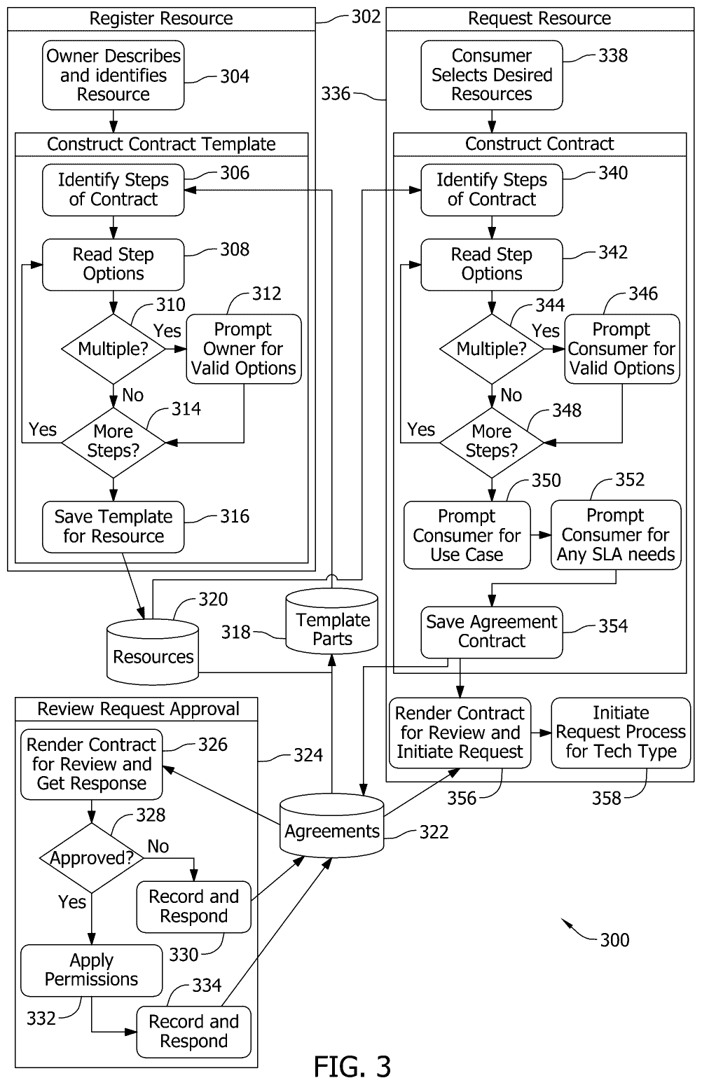

FIG. 3 depicts another exemplary flowchart 300 of a plurality of processing blocks such as registering 302 a resource, requesting 336 access to the registered resource and/or reviewing and approving 324 the request for data access. At least some of these processing blocks may be performed or executed by or via the DC computing device 101 and some processing blocks may be executed by or at a computing device associated with a data consumer 124 or a data product 126 (all shown in FIG. 1). The registering 302 a resource may include a data producer 126 describing and identifying types of data that the data producer 126 agrees to publish and make available to one or more data consumers 124. Based upon the description or information provided by the data producer 126 to publish a data resource or dataset, actions or operations of a contract may be identified 306 using a plurality of template parts stored in a database table 318. The template parts may include example template parts from historic contracts between data producers 126 and data consumers 124 that are saved in a database table 322 and other resources saved in a database table 320. The data producer 126 may read, review, edit, and/or approve each action or operation of the identified actions or operations of the contract 306, as shown in FIG. 3 as processing block 308. If there are multiple options 310 for a particular act or operation of the contract, the data producer 126 may be prompted 312 to select valid options. Operations associated with processing blocks 308, 310, and 312 may be repeated 314 for each action or operation when multiple actions or template parts are identified 306. After iterating based upon each action or operation, the template may be generated and saved 316 for the particular data source or dataset in the database table 320.

The data consumer 124 may request 336 access to the registered resource by selecting 338 a particular or desired data resource or dataset. In order to construct a data contract 104 (shown in FIG. 1) or a data control contract 204 (shown in FIG. 2), the actions or operations of the contract may be identified 340 based upon the template stored in the database table 320 corresponding to the selected data resource or dataset by the data consumer 124. The template may include one or more template parts and the data consumer 124 may read, review, edit, and/or approve each action or operation of identified actions or operations of the contract 340, as shown in FIG. 3 as processing block 342.

If there are multiple options 344 for a particular action or operation of the contract, the data consumer 124 may be prompted 346 to select valid options. Operations associated with processing blocks 342, 344, and 346 may be repeated 348 for each action or operation when multiple actions or operations or template parts are identified 340. After iterating based upon each action or operation, the data consumer 124 may be asked or prompted 350 to provide a business case or a use case describing how the data consumer 124 intends to use the data from the data source or dataset if the access is granted. Additionally, or alternatively, the data consumer 124 may also be prompted 352 to provide inputs for SLA for the data source or dataset. Based upon the inputs from the data consumer 124 and the data producer 126, the data contract may be generated and saved 354 in the database table 322. The data contract may be automatically and dynamically generated (e.g., by the DC computing device 101) using artificial intelligence-based algorithms based upon the inputs received from the data producer 126 and the data consumer 124.

In some cases, the data producer's 126 approval may be required before the data consumer 124 is granted access to the dataset. Accordingly, reviewing and approving the request for data access 324 may include rendering 326 the contract saved in the database 322 for review and approval by the data producer 126. When the data producer 126 approves 328 the contract, permissions and/or restrictions as agreed upon by the data producer 126 and the data consumer 124 in the data contract may be applied 332 and recorded 334 for saving in the database table 322. When the data producer 126 does not approve 328 the contract, the denial may be recorded 330 for saving in the database table 322.

The contract approved by the data producer 126 and saved in the database table 322 may be rendered 356 for review by the data consumer 124, and upon approval by the data consumer 124, various processes related to granting the data access request, enforcing data integrity, security, and/or reliability may be automatically initiated 358. Additionally, or alternatively, a data audit process may also be initiated to ensure that the data consumer 124 is using data according to the rules and/or restrictions in the data contract (e.g., the data contract 204 or the data control contract 104) as imposed by the data producer 126. The flowchart 300 shown in FIG. 3 may include additional, fewer, or alternate actions, including those discussed elsewhere herein.

### Exemplary User Device

FIG. 4 depicts an exemplary configuration of a user computing device (or a user device or user equipment) 400 in accordance with one embodiment of the present disclosure. The user device 400 may be, for example, a mobile device, smart home controller, a smart watch, smart contact lenses, augmented reality (AR) glasses, virtual reality (VR) headset, mixed or extended reality headset or glasses, wearables, voice or chat bot, an IOT device, other input device, and/or other electronic or electrical devices.

The user device 400 may include a processor 404 for executing instructions. In some embodiments, executable instructions may be stored in a memory 406. The processor 404 may include one or more processing units (e.g., in a multi-core configuration). The memory 406 may be any device allowing information such as executable instructions and/or transaction data to be stored and retrieved. The memory 406 may include one or more computer readable media.

The user device 400 may also include at least one media output component 408 for displaying a dashboard or information to the user. The media output component 408 may be any component capable of conveying information to a user 402. In some embodiments, the media output component 408 may include an output adapter (not shown) such as a video adapter and/or an audio adapter. An output adapter may be operatively coupled to the processor 404 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, the media output component 408 may be configured to present a graphical user interface (e.g., a web browser and/or a client application) to the user 402. A graphical user interface may include, for example, an interface for viewing prompts and data. In some embodiments, the user equipment 400 may include an input device 410 for receiving input from the user 402. The user 402 may use the input device 410 to, without limitation, provide user input. The user 402 may be a data producer 126 and/or a data consumer 124.

The input device 410 may include, for example, a keyboard, a pointing device, a mouse, a stylus, a touch sensitive panel (e.g., a touch pad or a touch screen), a biometric input device, at least one vision sensor (e.g., a camera or a video camera), and/or an audio input device such as a microphone. A single component such as a touch screen display may function as both an output device of the media output component 408 and the input device 410.

The user device 400 may also include a communication interface 412, communicatively coupled to a backend system, an application server, and/or one or more servers. The communication interface 412 may include, for example, a wired or wireless network adapter and/or a wireless data transceiver for use with a network (e.g., a Wi-Fi network, an Internet, a 3G/4G/5G/6G network, a WiMAX network, etc.).

Stored in the memory 406 are, for example, computer readable instructions for providing a user interface to the user via the media output component 408 and, optionally, receiving and processing input from the input device 410. A user interface may include, among other possibilities, a web browser and/or a client application. Web browsers enable users, such as user, to display and interact with media and other information typically embedded on a web page or a website from the backend system. A client application (e.g., a frontend application executing on the user device 400) may allow the user 402 to interact with, for example, the backend system (e.g., the DC computing device 101, shown in FIG. 1).

In some embodiments, the user device 400 may include one or more sensors 414. By way of a non-limiting example, the one or more sensors 414 may include, but is not limited to, a gyroscope, an accelerometer, a position detector, a temperature sensor, a lux sensor (or a light level sensor), a water level sensor, an air composition sensor, an image sensor, a voice/sound sensor, a pressure sensor, a humidity sensor, an accelerometer, an infrared sensor, a vibration sensor, and/or an ultrasonic sensor.

### Exemplary Application Server

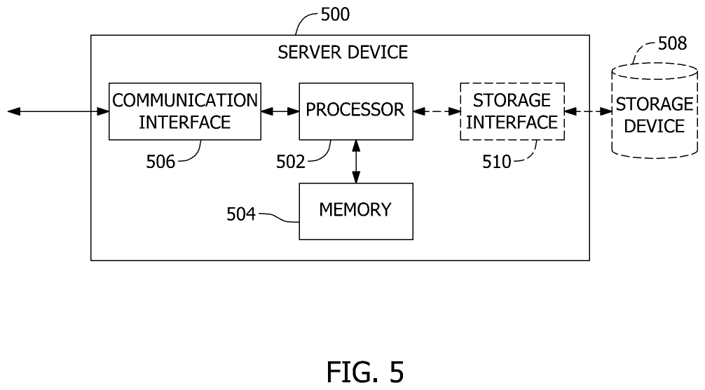

FIG. 5 depicts an exemplary configuration of an application server 500 of a backend system in accordance with one embodiment of the present disclosure. Application server 500 may also be referred to as the DC computing device, and may be configured to perform various operations, as described herein with reference to FIG. 2 and FIG. 3, from the backend system perspective.

The application server 500 may include a processor 502 having one or more processing units (e.g., in a multi-core configuration). The processor 502 may be operatively coupled to a communication interface 506 such that the application server 500 is capable of communicating with a remote device, such as another application server 500 or the user device 400, for example, via the network, using wireless communication or data transmission over one or more radio links or digital communication channels. For example, the communication interface 506 may receive data, e.g., image, video, and/or text. By way of a non-limiting example, the application server 500 may be a server which may receive registered data and/or data access requests from a user and transmit data to the user.

The processor 502 may also be operatively coupled to a storage device 508. The storage device 508 may be any computer-operated hardware suitable for storing and/or retrieving data, such as, but not limited to, data associated with historic databases. In some embodiments, the storage device 508 may be integrated in the application server 500. For example, the application server 500 may include one or more hard disk drives as the storage device 508.

In other embodiments, the storage device 508 may be external to the application server 500 and may be accessed by a plurality of user devices 400. For example, the storage device 508 may include a storage area network (SAN), a network attached storage (NAS) system, and/or multiple storage units such as hard disks and/or solid-state disks in a redundant array of inexpensive disks (RAID) configuration.

In some embodiments, the processor 502 may be operatively coupled to the storage device 508 via a storage interface 510. The storage interface 510 may be any component capable of providing the processor 502 with access to the storage device 508. The storage interface 510 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 502 with access to the storage device 508.

The processor 502 may execute computer-executable instructions for implementing aspects of the disclosure. In some embodiments, the processor 502 may be transformed into a special purpose microprocessor by executing computer-executable instructions or by otherwise being programmed. In some embodiments, and by way of a non-limiting example, the memory 504 may include instructions to perform specific operations, as described herein.

Exemplary Views of a Web-Browser Based Application or a Mobile Application Executing on a User Device of a Data Producer and/or a Data Consumer

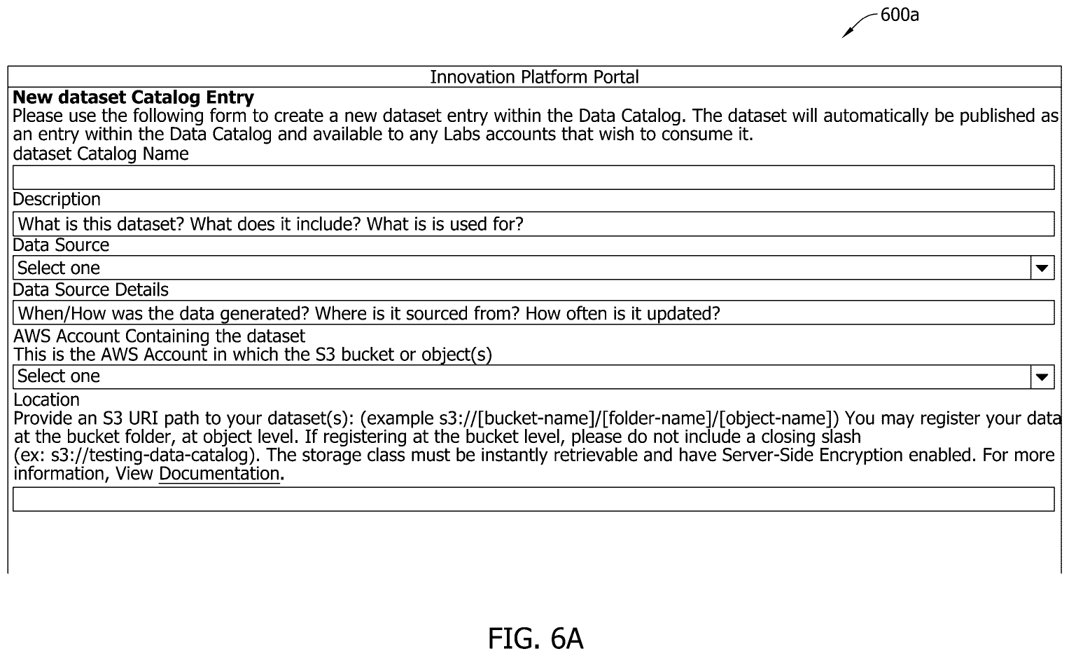

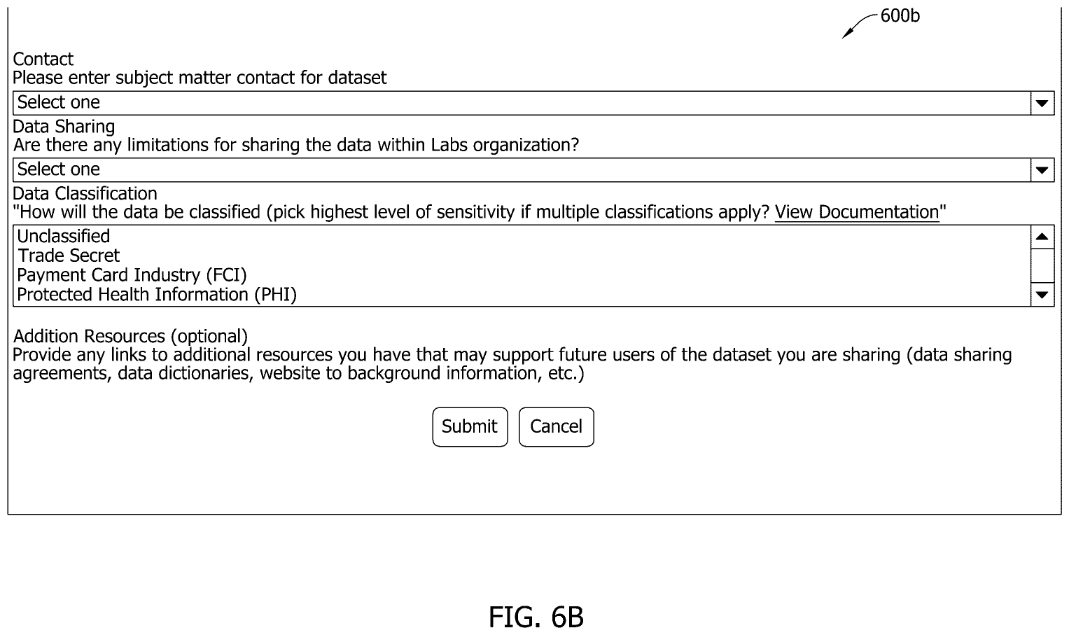

FIGS. 6A-6B depict exemplary user interfaces or screen views 600a and 600b of a web-browser based application or a mobile application executing on a user device or user equipment 400 (shown in FIG. 4) of a data producer 126 and/or a data consumer 124 in accordance with one embodiment of the present disclosure. As shown in FIG. 6A and FIG. 6B, exemplary partial or full screen views or user interfaces 600a and 600b correspond with creating a new dataset catalog entry by the data producer 126. The data producer 126 may provide inputs to a plurality of fields including, but not limited to, a dataset catalog name, a description of the dataset, a data source, details of the data source, an account or user credential details of the data producer's 126 database or webservices, a directory path of the data source, contact information of the data producer 126, data sharing options, and/or data classification details of the dataset, etc. The data producer 126 may provide input to the plurality of fields as text input and/or selecting one or more options from a list. The list may be displayed to the data producer 126 as a pull-down menu list.

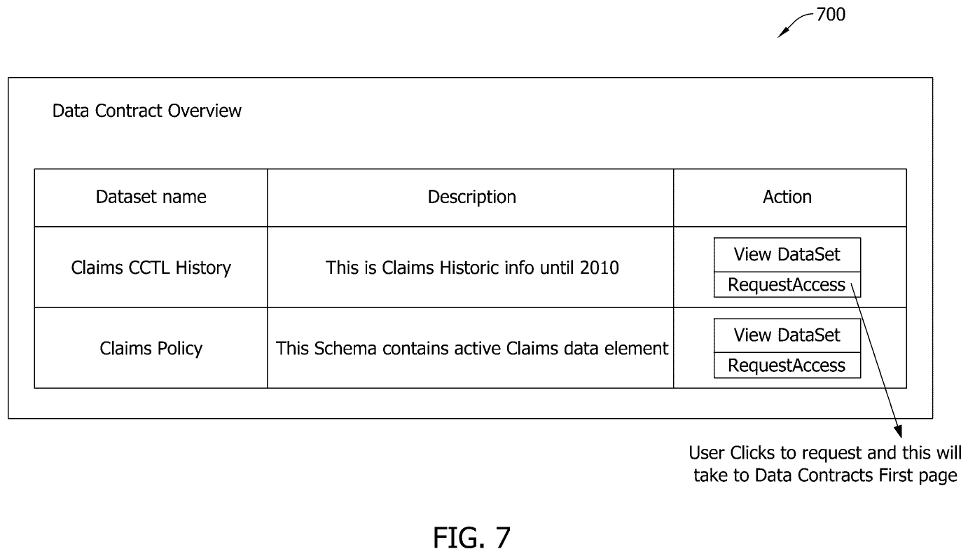

FIG. 7 illustrates an exemplary partial or full screen view or user interface 700 of one or more dataset catalog entries added or registered by the data producer 126. As shown in FIG. 7, a name of the dataset and corresponding description of dataset may be displayed to a data consumer 124 along with one or more actions that may be performed for the dataset. By way of a non-limiting example, the data consumer 124 may view the dataset and/or request access to the dataset.

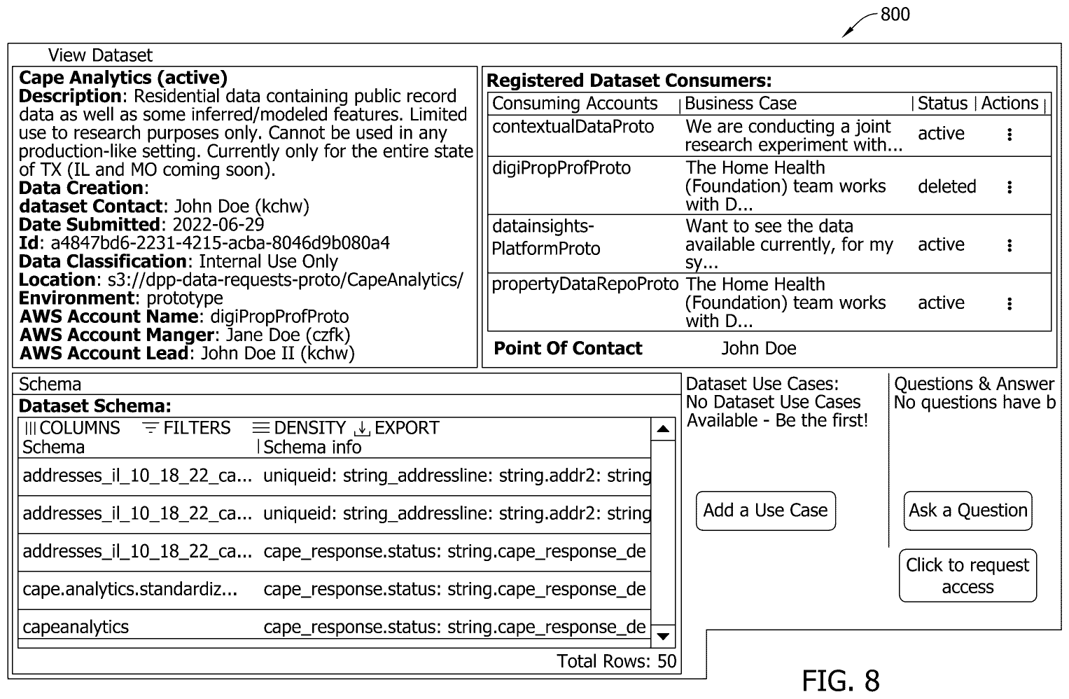

FIG. 8 illustrates an exemplary partial or full screen view or user interface 800 providing details of a dataset when the consumer 124 selects a an option to view a particular dataset, such as the “View DataSet” option as shown in FIG. 7. By way of a non-limiting example, when the data consumer 124 selects this option, cape analytics, schema details, one or more other data consumers of the selected dataset, a point of contact for the data producer 126 for the selected dataset, use case information for the dataset, and other information related to the dataset may be displayed. Additionally, or alternatively, the data consumer 124 may also be able to request access to the dataset from this user interface.

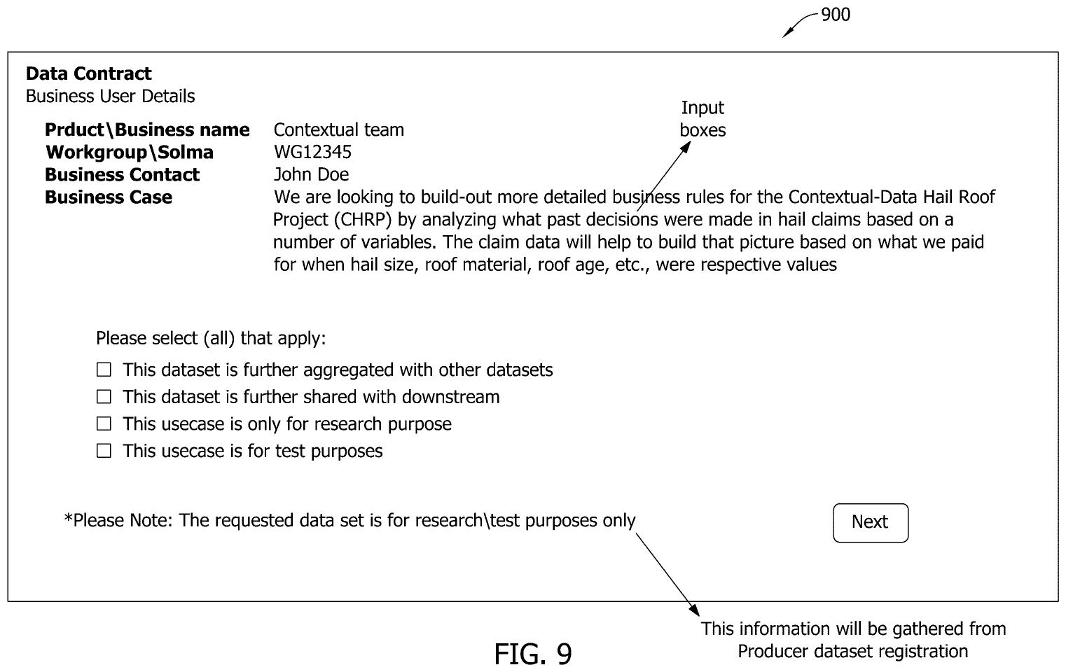

FIG. 9 illustrates an exemplary partial or full screen view or user interface 900 for receiving inputs from a data consumer 124. In other words, the data consumer 124 may provide inputs to a questionnaire presented in the screen view or user interface 900. The data consumer 124 may provide inputs for a business case or a user case for which the data consumer 124 is requesting data access, and a purpose and sharing options if the data consumer's 124 request for data access is granted.

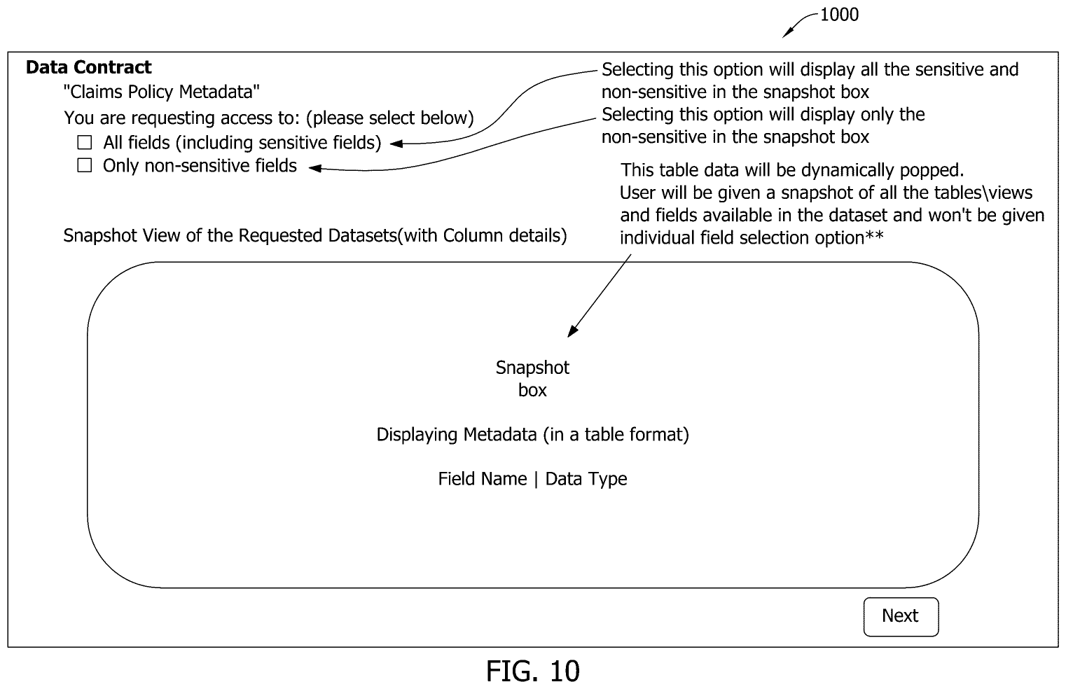

FIG. 10 illustrates an exemplary partial or full screen view or user interface 1000 for receiving further user inputs from the data consumer 124 regarding whether the data consumer is requesting access to all types of data elements including sensitive data elements or just non-sensitive data elements. As shown in FIG. 10, a snapshot view of the requested dataset including various data elements, data types, and/or metadata may be displayed to the data consumer 124.

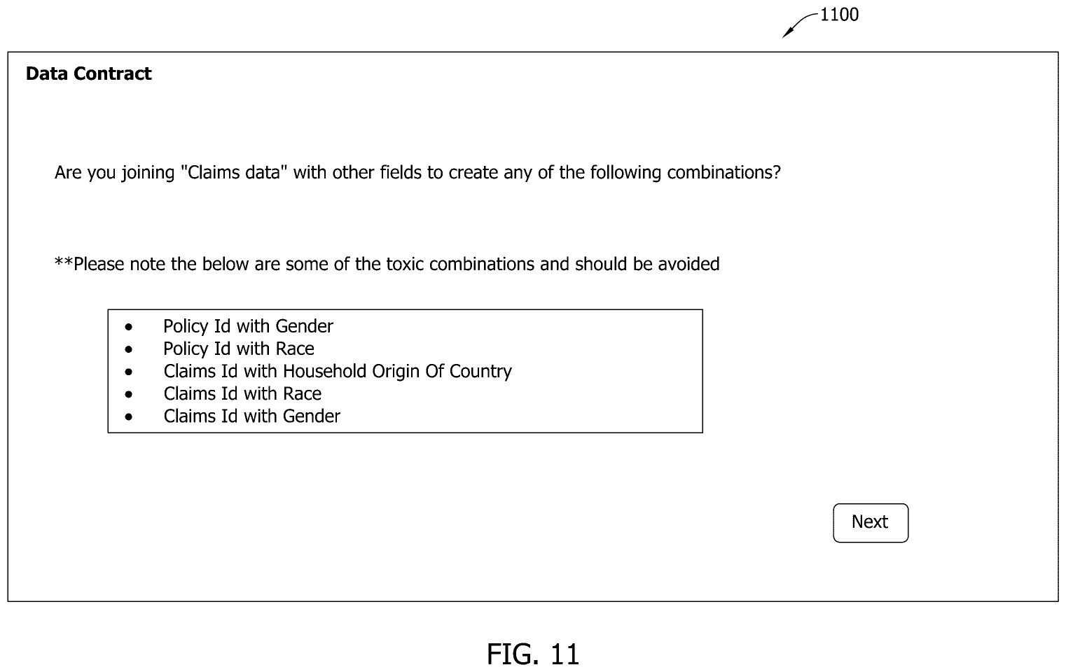

FIG. 11 illustrates an exemplary partial or full screen view or user interface 1100 for receiving further user inputs from the data consumer 124 regarding toxic combinations and providing a warning to the data consumer 124 that the data should not be used in combination with certain types of other data including gender, race, household country of origin, etc.

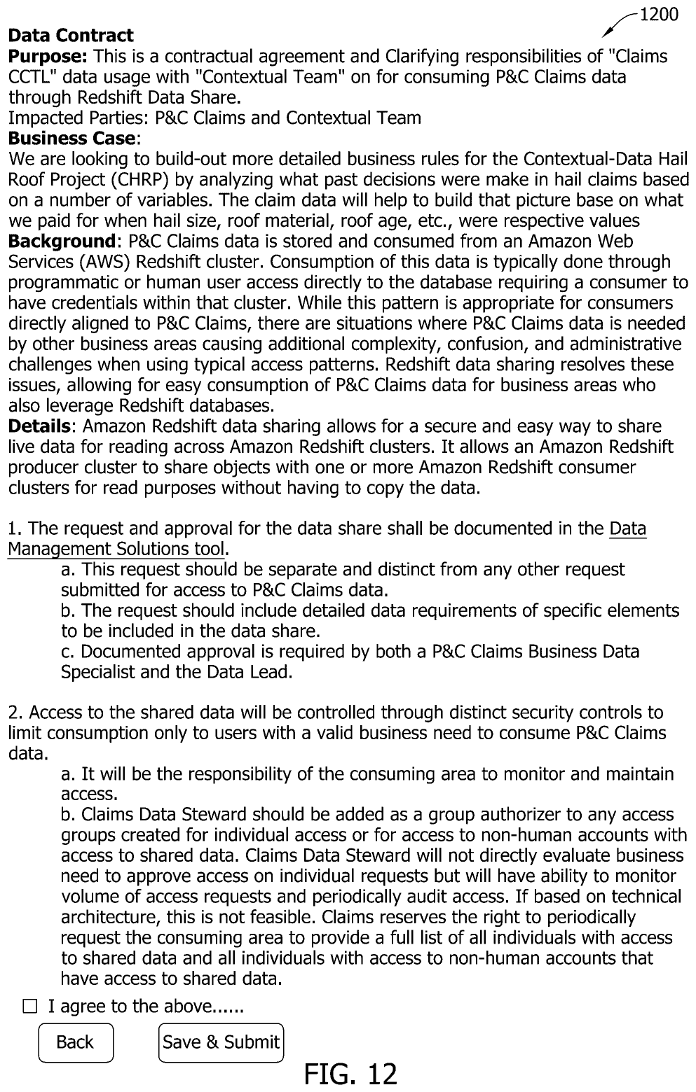

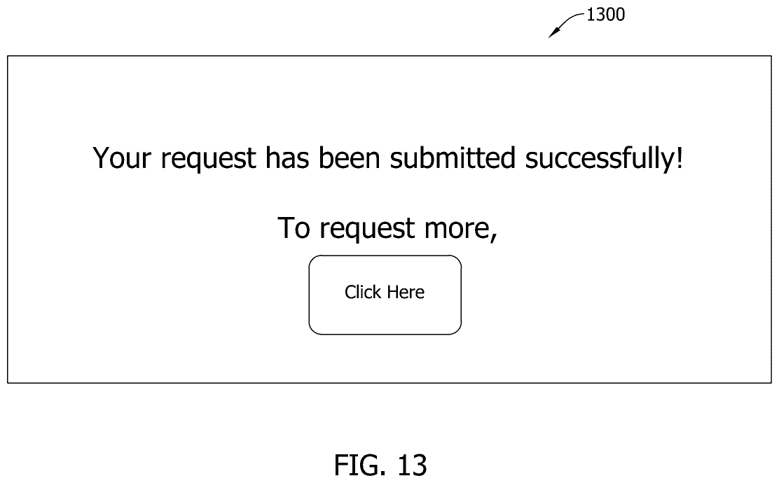

FIG. 12 illustrates an exemplary partial or full screen view or user interface 1200 displaying an automatically and dynamically generated data contract or data control contract based upon inputs received from the data producer 126 and the data consumer 124. Upon the data consumer 124's acceptance of the terms and conditions of the generated data control contract, a notification of the successful submission of the data consumer's 124 request may be displayed as shown in a partial or full screen view or user interface 1300 of FIG. 13.

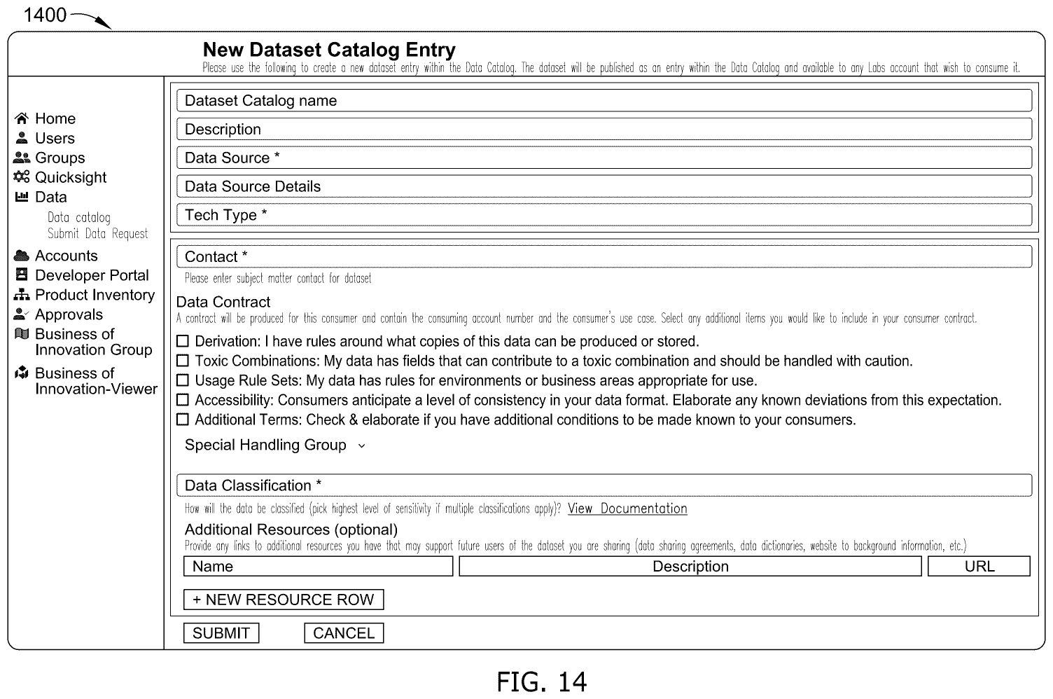

FIG. 14 illustrates another exemplary partial or full screen view or user interface 1400 for creating a new dataset catalog entry by the data producer 126. The data producer 126 may provide inputs to a plurality of fields including, but not limited to, a dataset catalog name, a description of the dataset, a data source, details of the data source, an account or user credential details of the data producer's 126 database or webservices, a directory path of the data source, contact information of the data producer 126, data sharing options, and/or data classification details of the dataset, etc. The data producer 126 may provide input to the plurality of fields as text input and/or selecting one or more options from a list. The list may be displayed to the data producer 126 as a pull-down menu list.

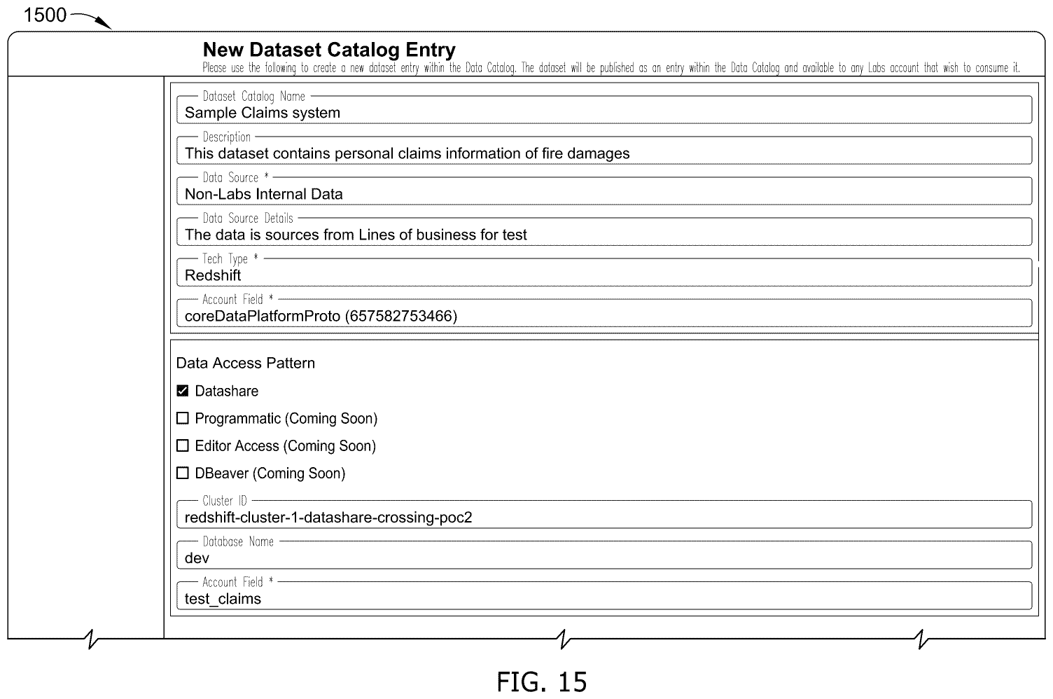

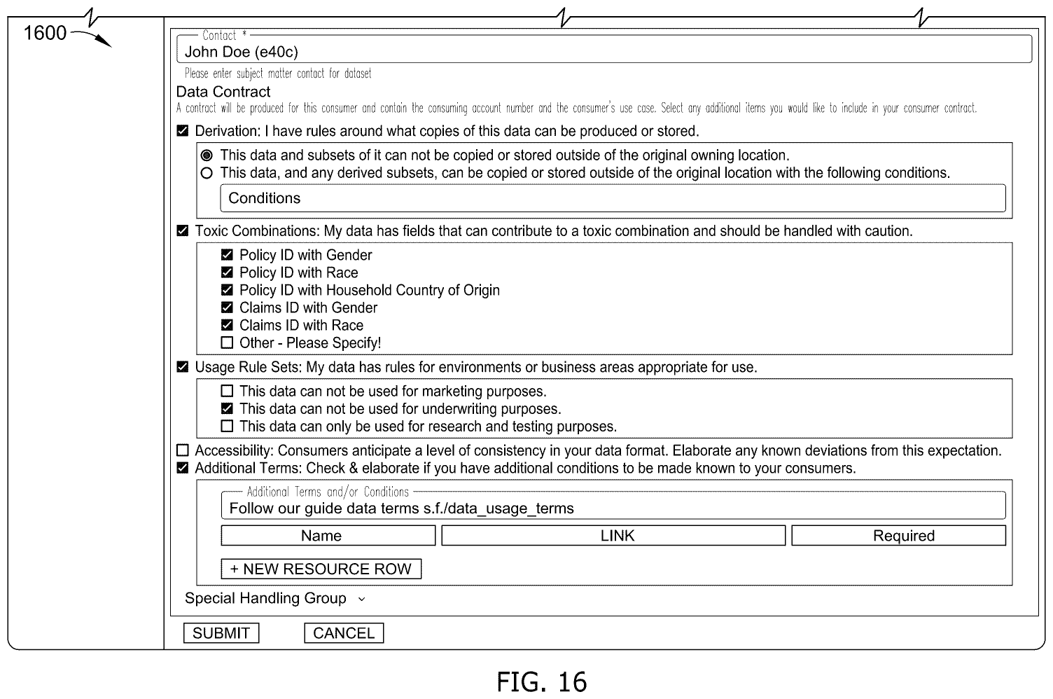

FIG. 15 illustrates another exemplary partial or full screen view or user interface 1500 for creating a new dataset catalog entry by the data producer 126. FIG. 16 illustrates another exemplary partial or full screen view or user interface 1600, which may be a continuation of user interface 1500. User interfaces 1500 and 1600 may be, for example, example states of portions of user interface 1400 once populated with data by the data producer 126.

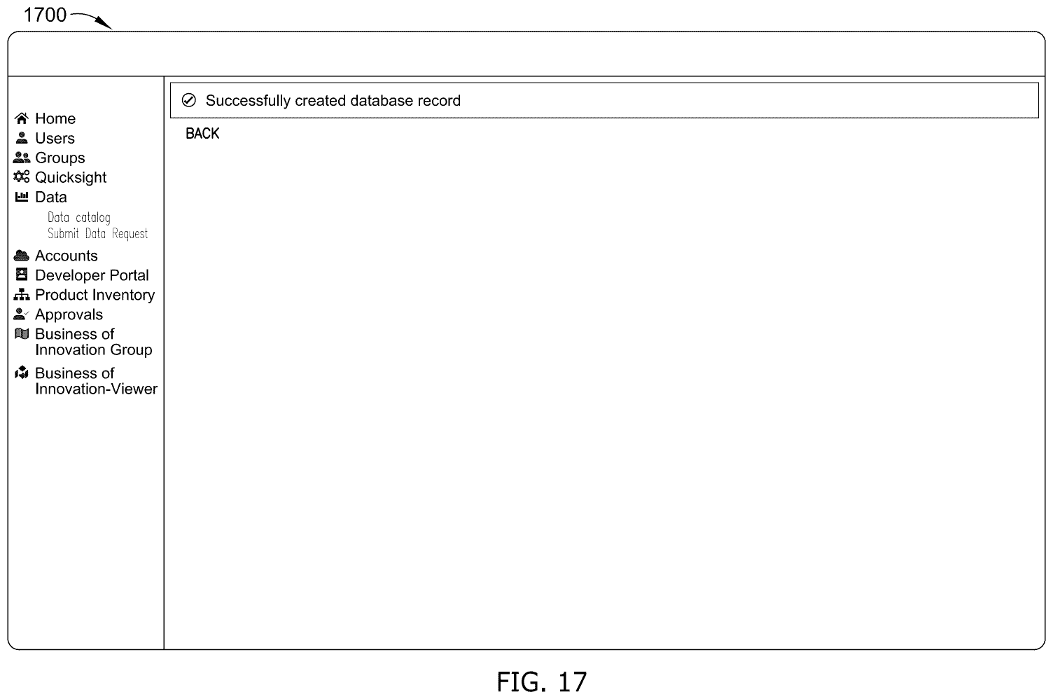

FIG. 17 illustrates an exemplary partial or full screen view or user interface 1700, which may be displayed to data producer 126 upon a successful creation of a new data set, for example, via user interfaces 1400, 1500, and/or 1600.

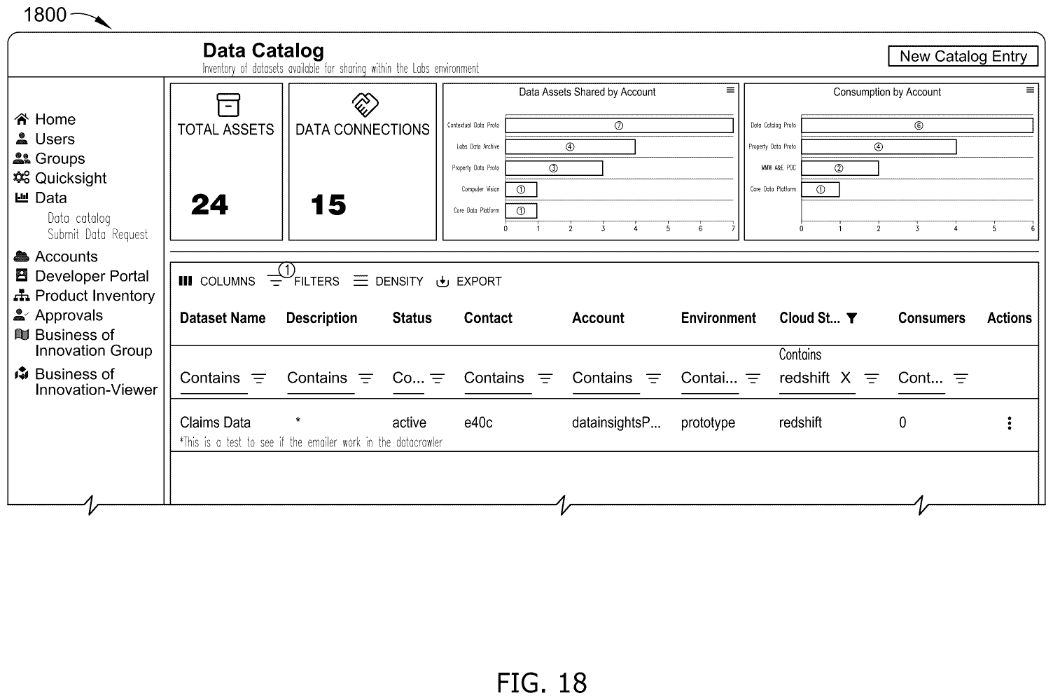

FIG. 18 illustrates an exemplary partial or full screen view or user interface 1800 dashboard view indicating that dataset was added of a data catalog including one or more dataset catalog entries added or registered by the data producer 126. As shown in FIG. 18, user interface 1800 may include information about the data catalog as a whole as well as a name and corresponding description of each dataset, which may be displayed to a data consumer 124 along with one or more actions that may be performed for the dataset. By way of a non-limiting example, the data consumer 124 may view dataset and/or request access to one of the displayed datasets.

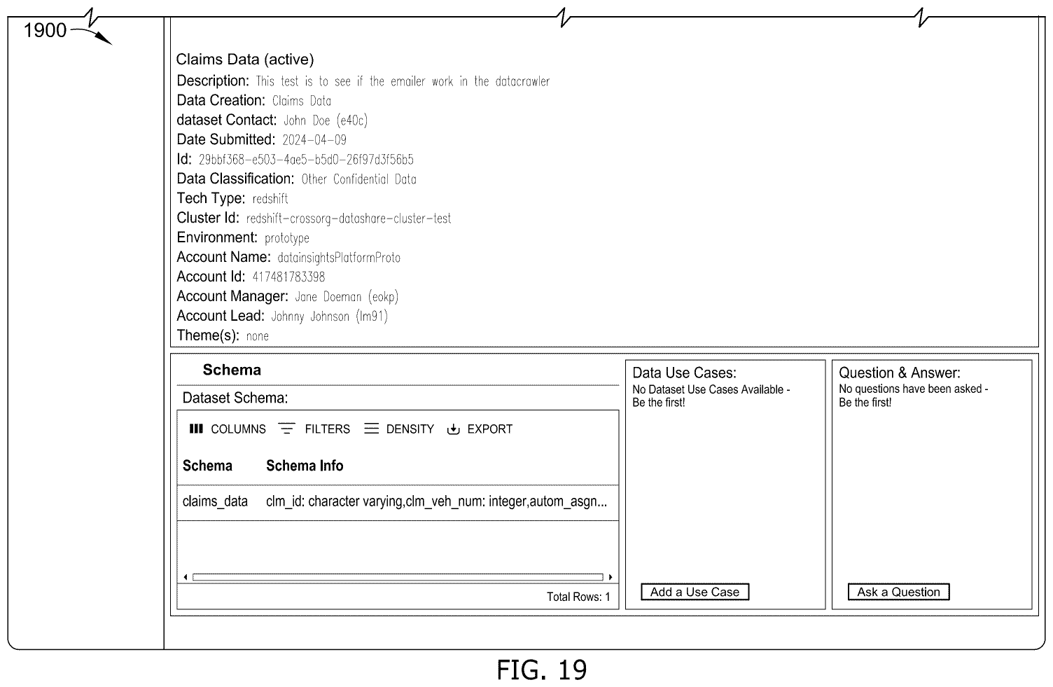

FIG. 19 illustrates an exemplary partial or full screen view or user interface 1900, which may be a continuation of user interface 1800, or may be displayed when the consumer 124 selects an option to view a particular dataset (e.g., through user interface 1800). User interface 1800 may include cape analytics, schema details, one or more other data consumers of the selected dataset, a point of contact for the data producer 126 for the selected dataset, use case information for the dataset, and other information related to the dataset may be displayed. Additionally, or alternatively, the data consumer 124 may also be able to request access to the dataset from this user interface.

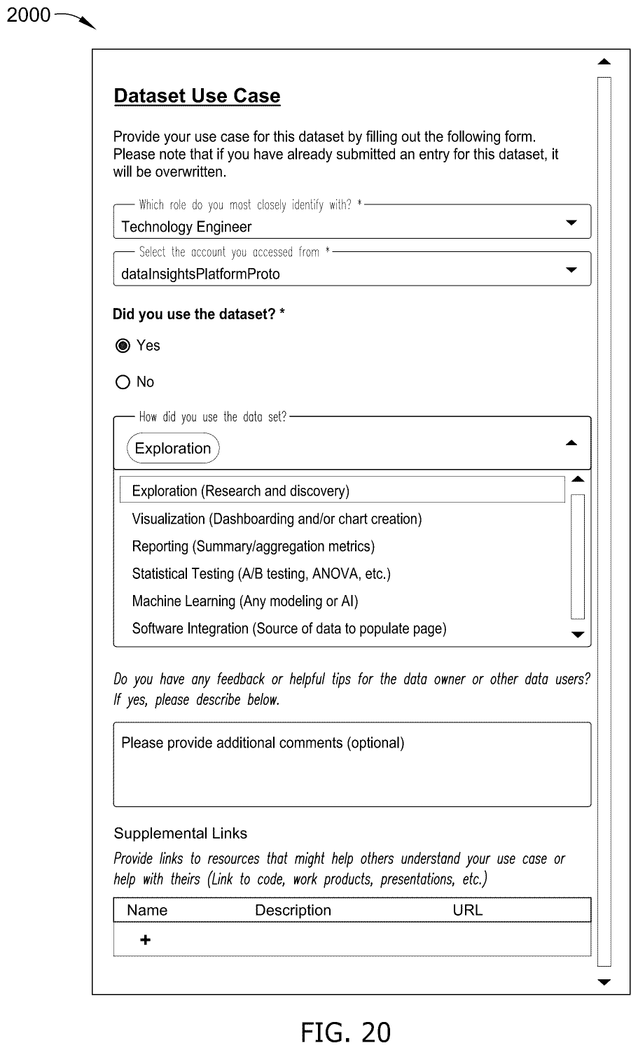

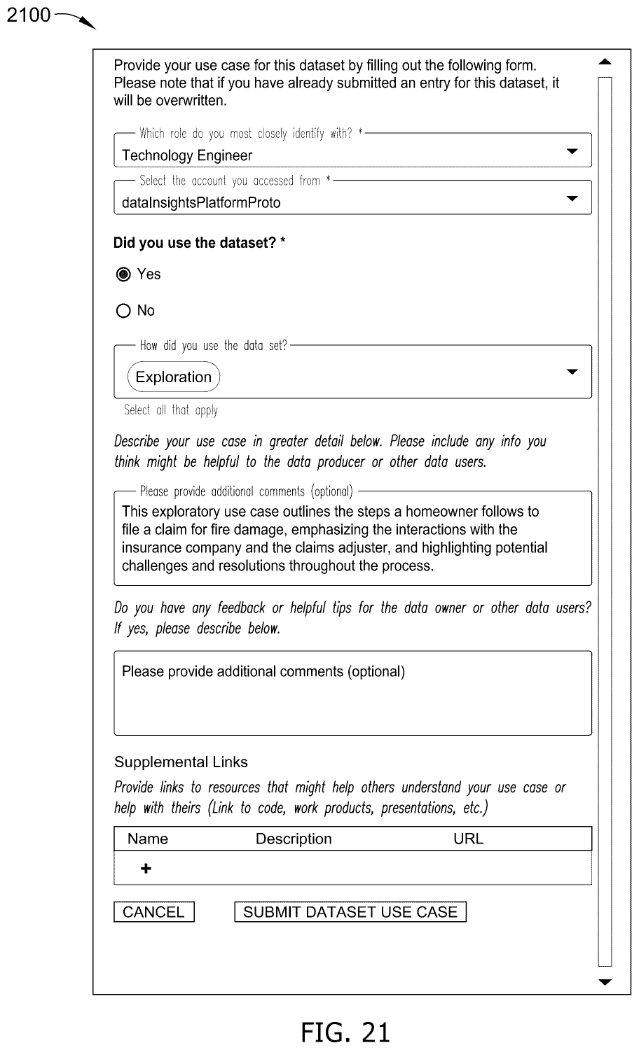

FIG. 20 illustrates an exemplary partial or full screen view or user interface 2000 for receiving inputs from a data consumer 124. FIG. 21 illustrates another exemplary partial or full screen view or user interface 2100, which may be a continuation of user interface 2000. The data consumer 124 may provide inputs to a questionnaire presented in the screen view or user interfaces 2000 and 2100. The data consumer 124 may provide inputs for a business case or a user case for which the data consumer 124 is requesting data access, and a purpose and sharing options if the data consumer's 124 request for data access is granted.

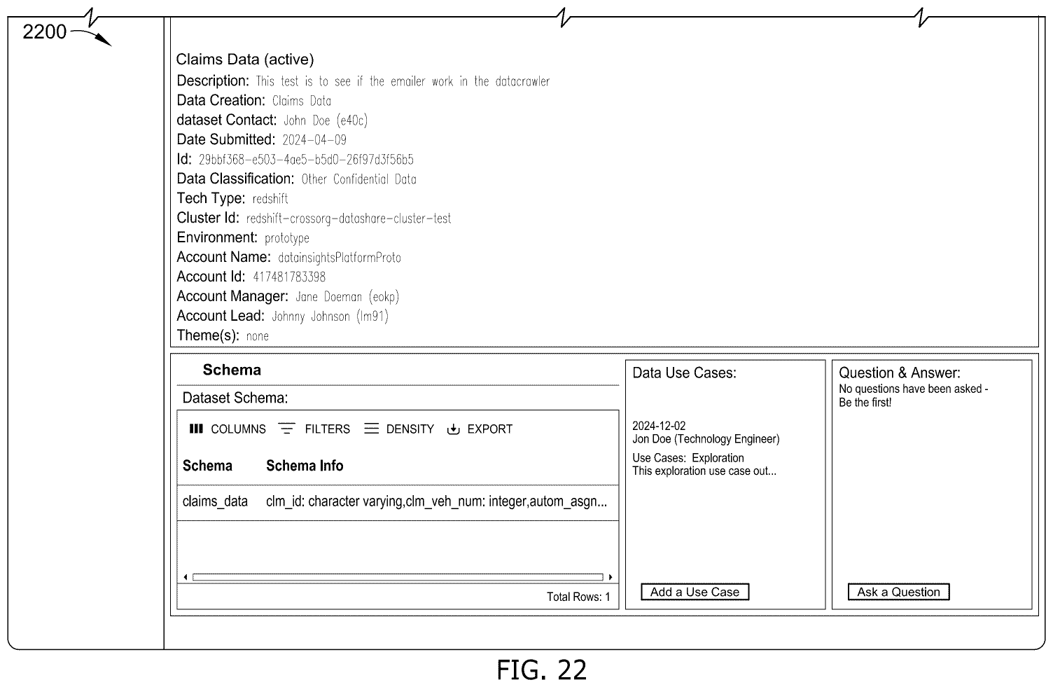

FIG. 22 illustrates an exemplary partial or full screen view or user interface 2200, which may be a subsequent state of user interface 1900 after a business case or a user case has been submitted (e.g., through user interfaces 2000 and/or 2100). User interface 2200 may include information relating to the submitted case such as a date of submission, the data consumer 124 who submitted, and/or other related information.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, the DC computing device 101 may be configured to implement machine learning, such that a computer system “learns” to analyze, organize, and/or process data without being explicitly programmed. Machine learning may be implemented through machine learning methods and algorithms (“ML methods and algorithms”). In one exemplary embodiment, a machine learning module (“ML module”) is configured to implement ML methods and algorithms. In some embodiments, ML methods and algorithms are applied to data inputs and generate machine learning outputs (“NIL outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The exemplary inputs and example outputs of the training data may include any of the data inputs or ML outputs described above. In the exemplary embodiment, a processing element may be trained by providing it with a large sample of images with known characteristics or features or with a large sample of other data with known characteristics or features. Such information may include, for example, information associated with a plurality of images and/or other data of a plurality of different objects, items, persons, and/or property including appliances and/or other systems.

In another embodiment, an ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, an ML module may employ reinforcement learning, which involves optimizing outputs based upon feedback from a reward signal. Specifically, the ML module may receive a user-defined reward signal definition, receive a data input, utilize a decision-making model to generate an ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and voice bots or chatbots may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text, or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### Additional Exemplary Embodiments

Additional exemplary embodiments of the systems and methods described herein are provided herein. For example, in one embodiment, a computing system for generating a data contract between a data producer and a data consumer for usage of a data resource may include at least one memory and at least one processor in communication with the at least one memory. The at least one processor may be programmed to: (i) generate a first interface for the data producer to register the data resource and to input conditions for using data of the data resource; (ii) cause the registered data resource to be added in a data catalog; (iii) generate a second interface for the data consumer to search the data catalog and request access to the data resource; (iv) generate a third interface for the data consumer to input a use case for the data resource; and/or (v) generate the data contract based at least in part upon the conditions for using data of the data resource and based at least in part upon the use case inputted by the data consumer.

Further, the computing system in accordance with the preceding aspects may further include wherein the at least one processor is further programmed to validate a subsequent data access request from the data consumer against the generated data contract.

Further, the computing system in accordance with the preceding aspects may further include wherein the at least one processor is further programmed to determine whether an approval from the data producer is required to grant access to the data resource to the data consumer for the use case inputted by the data consumer.

Further, the computing system in accordance with the preceding aspects may further include wherein the at least one processor is further programmed to request approval from the data producer of the use case prior to generating the contract.

Further, the computing system in accordance with the preceding aspects may further include wherein the at least one processor is further programmed to: (i) store the generated data contract in a database; and/or (ii) render the generated data contract for viewing by another data consumer in response to another request for access to the data resource.

Further, the computing system in accordance with the preceding aspects may further include wherein a first component of the generated data contract includes metadata defining data format standardization and consistency rules.

Further, the computing system in accordance with the preceding aspects may further include wherein the at least one processor is further programmed to generate a fourth interface to allow the data producer to select a schema from a list of schemas for the data contract.

Further, the computing system in accordance with the preceding aspects may further include wherein the conditions for using data of the data resource include using data of the data resource for one or more use cases or using data of the data resource in a particular organization environment.

Further, the computing system in accordance with the preceding aspects may further include wherein the at least one processor is further configured to generate a fifth interface for the data consumer to select one or more access patterns related to use of the data resource by the data consumer.

Further, the computing system in accordance with the preceding aspects may further include wherein the at least one processor is further configured to generate a sixth interface for the data consumer to select one or more access patterns associated with technical support and setup of using data of the data resource.

Further, the computing system in accordance with the preceding aspects may further include wherein the at least one processor is further programmed to determine whether an approval from the data producer is required to grant access to the data resource to the data consumer for the use case inputted by the data consumer.

Further, the computing system in accordance with the preceding aspects may further include wherein the at least one processor is further programmed to initiate one or more processes automatically to: (i) grant access to the data resource to the data consumer; and/or (ii) initiate a data audit to enforce data integrity, security, and reliability of use of the data by the data consumer.

In another embodiment, a computer-implemented method for generating a data contract between a data producer and a data consumer for usage of a data resource is disclosed. The computer-implemented method, which may be implemented using one or more processors, may include: (i) generating a first interface for the data producer to register the data resource and to input conditions for using data of the data resource; (ii) causing the registered data resource to be added in a data catalog; (iii) generating a second interface for the data consumer to search the data catalog and request access to the data resource; (iv) generating a third interface for the data consumer to input a use case for the data resource; and/or (v) generating the data contract based at least in part upon the conditions for using data of the data resource and based at least in part upon the use case inputted by the data consumer.

Further, the computer-implemented method in accordance with the preceding operations may further include generating a fourth interface to allow the data producer to select a schema from a list of schemas for the data contract.

Further, the computer-implemented method in accordance with the preceding operations may further include validating a subsequent data access request from the data consumer against the generated data contract.

Further, the computer-implemented method in accordance with the preceding operations may further include determining whether an approval from the data producer is required to grant access to the data resource to the data consumer for the use case inputted by the data consumer.

Further, the computer-implemented method in accordance with the preceding operations may further include requesting approval from the data producer of the use case prior to the generating the data contract.

Further, the computer-implemented method in accordance with the preceding operations may further include: (i) storing the generated data contract in a database; and/or (ii) rendering the generated data contract for viewing by another data consumer in response to another request for access to the data resource.

Additionally, or alternatively, the computer-implemented method in accordance with any of the preceding operations may further include wherein the conditions for using data of the data resource include using data of the data resource for one or more use cases or using data of the data resource in a particular organization environment.

In addition, the computer-implemented method in accordance with any of the preceding operations may further include generating a fifth interface to allow the data producer to select a schema from a list of schemas for the data contract.

In addition, the computer-implemented method in accordance with any of the preceding operations may further include generating a sixth interface for the data consumer to select one or more access patterns associated with technical support and setup of using data of the data resource.

Further, the computer-implemented method in accordance with the preceding operations may further include generating a fifth interface for the data consumer to select one or more access patterns related to use of the data resource by the data consumer.

In addition, the computer-implemented method in accordance with any of the preceding operations may further include determining whether an approval from the data producer is required to grant access to the data resource to the data consumer for the use case inputted by the data consumer.

In addition, the computer-implemented method in accordance with any of the preceding operations may further include initiating one or more processes automatically to: (i) grant access to the data resource to the data consumer; and/or (ii) initiate a data audit to enforce data integrity, security, and reliability of use of the data by the data consumer.

In one aspect, at least one non-transitory computer-readable storage media having instructions stored thereon is disclosed. The instructions, when executed by at least one processor of a computing system for generating a data contract between a data producer and a data consumer for usage of a data resource, cause the at least one processor to: (i) generate a first interface for the data producer to register the data resource and to input conditions for using data of the data resource; (ii) cause the registered data resource to be added in a data catalog; (iii) generate a second interface for the data consumer to search the data catalog and request access to the data resource; (iv) generate a third interface for the data consumer to input a use case for the data resource; and/or (v) generate the data contract based at least in part upon the conditions for using data of the data resource and based at least in part upon the use case inputted by the data consumer.

Further, the at least one non-transitory computer-readable storage media with instructions embodied thereon in accordance with the preceding aspects may further include wherein the instructions further cause the at least one processor to generate a fourth interface to allow the data producer to select a schema from a list of schemas for the data contract.

Further, the at least one non-transitory computer-readable storage media with instructions embodied thereon in accordance with the preceding aspects may further include wherein the instructions further cause the at least one processor to generate a fifth interface to allow the data producer to select a schema from a list of schemas for the data contract.

Further, the at least one non-transitory computer-readable storage media with instructions embodied thereon in accordance with the preceding aspects may further include wherein the instructions further cause the at least one processor to generate a sixth interface for the data consumer to select one or more access patterns associated with technical support and setup of using data of the data resource.

Further, the at least one non-transitory computer-readable storage media with instructions embodied thereon in accordance with the preceding aspects may further include wherein the instructions further cause the at least one processor to determine whether an approval from the data producer is required to grant access to the data resource to the data consumer for the use case inputted by the data consumer.

Further, the at least one non-transitory computer-readable storage media with instructions embodied thereon in accordance with the preceding aspects may further include wherein the instructions further cause the at least one processor to initiate one or more processes automatically to grant access to the data resource to the data consumer and to enforce data integrity, security, reliability, and data audit.

Further, the at least one non-transitory computer-readable storage media with instructions embodied thereon in accordance with the preceding aspects may further include wherein the instructions further cause the at least one processor to request approval from the data producer of the use case prior to generating the contract.

Further, the at least one non-transitory computer-readable storage media with instructions embodied thereon in accordance with the preceding aspects may further include wherein a first component of the generated data contract includes metadata defining data format standardization and consistency rules.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system may be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element, action, or operation recited in the singular and preceded by the word “a” or “an” should be understood as not excluding plural elements or actions, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing system for generating a data contract between a data producer and a data consumer for usage of a data resource, the computing system comprising:
at least one memory; and
at least one processor in communication with the at least one memory, wherein the at least one processor is programmed to:
generate a first interface for the data producer to register the data resource and to input conditions for using data of the data resource;
cause the registered data resource to be added in a data catalog;
generate a second interface for the data consumer to search the data catalog and request access to the data resource;
generate a third interface for the data consumer to input a use case for the data resource; and
generate the data contract based at least in part upon the conditions for using data of the data resource and the use case inputted by the data consumer.

2. The computing system of claim 1, wherein the at least one processor is further programmed to validate a subsequent data access request from the data consumer against the generated data contract.

3. The computing system of claim 1, wherein the at least one processor is further programmed to determine whether an approval from the data producer is required to grant access to the data resource to the data consumer for the use case inputted by the data consumer.

4. The computing system of claim 1, wherein the at least one processor is further programmed to request approval from the data producer of the use case prior to generating the data contract.

5. The computing system of claim 1, wherein the at least one processor is further programmed to:
store the generated data contract in a database; and
render the generated data contract for viewing by another data consumer in response to another request for access to the data resource.

6. The computing system of claim 1, wherein a first component of the generated data contract includes metadata defining data format standardization and consistency rules.

7. The computing system of claim 1, wherein the at least one processor is further programmed to generate a fourth interface for the data producer to select a schema from a list of schemas for the data contract.

8. The computing system of claim 1, wherein the at least one processor is further configured to generate a fifth interface for the data consumer to select one or more access patterns related to use of the data resource by the data consumer.

9. The computing system of claim 1, wherein the at least one processor is further programmed to initiate one or more processes automatically to:
grant access to the data resource to the data consumer; and
initiate a data audit to enforce data integrity, security, and reliability of use of the data by the data consumer.

10. A computer-implemented method for generating a data contract between a data producer and a data consumer for usage of a data resource, the method comprising:
generating a first interface for the data producer to register the data resource and to input conditions for using data of the data resource;
causing the registered data resource to be added in a data catalog;
generating a second interface for the data consumer to search the data catalog and request access to the data resource;
generating a third interface for the data consumer to input a use case for the data resource; and
generating the data contract based at least in part upon the conditions for using data of the data resource and based at least in part upon the use case inputted by the data consumer.

11. The computer-implemented method of claim 10, further comprising validating a subsequent data access request from the data consumer against the generated data contract.

12. The computer-implemented method of claim 10, further comprising determining whether an approval from the data producer is required to grant access to the data resource to the data consumer for the use case inputted by the data consumer.

13. The computer-implemented method of claim 10, further comprising requesting approval from the data producer of the use case prior to the generating the data contract.

14. The computer-implemented method of claim 10, further comprising:
storing the generated data contract in a database; and
rendering the generated data contract for viewing by another data consumer in response to another request for access to the data resource.

15. The computer-implemented method of claim 10, further comprising generating a fourth interface for the data producer to select a schema from a list of schemas for the data contract.

16. The computer-implemented method of claim 10, further comprising generating a fifth interface for the data consumer to select one or more access patterns related to use of the data resource by the data consumer.

17. The computer-implemented method of claim 10, further comprising initiating one or more processes automatically to:
grant access to the data resource to the data consumer; and
initiate a data audit to enforce data integrity, security, and reliability of use of the data by the data consumer.

18. At least one non-transitory computer-readable media (CRM) storing instructions thereon, which when executed by at least one processor of a computing system for generating a data contract between a data producer and a data consumer for usage of a data resource, cause the at least one processor to:
generate a first interface for the data producer to register the data resource and to input conditions for using data of the data resource;
cause the registered data resource to be added in a data catalog;
generate a second interface for the data consumer to search the data catalog and request access to the data resource;
generate a third interface for the data consumer to input a use case for the data resource; and
generate the data contract based at least in part upon the conditions for using data of the data resource and based at least in part upon the use case inputted by the data consumer.

19. The at least one non-transitory CRM of claim 18, wherein the instructions further cause the at least one processor to request approval from the data producer of the use case prior to generating the contract.

20. The at least one non-transitory CRM of claim 18, wherein a first component of the generated data contract includes metadata defining data format standardization and consistency rules.
